(19) United States
(12) Patent Application Publication
(10) Pub. No.: US 2008/0232326 A1
(43) Pub. Date: Sep. 25, 2008

(54) Method and Apparatus for Reducing Interference in Wireless Communication Networks by Enabling More Opportune Handover

(76) Inventors: Bengt Lindoff, Bjarred (SE); Bo Bernhardsson, Lund (SE); Arne Simonsson, Gammelstad (SE)

Correspondence Address: COATS & BENNETT, PLLC, 1400 Crescent Green, Suite 300, Cary, NC, 27518, US

(21) Appl. No.: 12/049,870

(22) Filed: Mar. 17, 2008

Related U.S. Application Data
(60) Provisional application No. 60/895,580, filed on Mar. 19, 2007.

(51) Int. Cl. H04Q 7/00

(52) U.S. Cl. 370/332

(57) ABSTRACT

According to the teachings presented herein, wireless communication network interference is reduced by sending handover measurement information from mobile stations in conjunction with sending uplink scheduling requests, and by correspondingly making combined handover and uplink resource scheduling decisions. In this context, the combined decision considers both the handover measurement information and the uplink scheduling request, and determines whether a serving cell grants or denies the request and whether handover from the serving cell to a neighboring cell is or is not initiated for the mobile station. The combined determination provides for timely handover of the mobile station, such as where the mobile station is operating near a cell edge and issues an uplink scheduling request to its currently serving cell.

### RELATED APPLICATIONS

This application claims priority under 35 U.S.C. §119(e) from the U.S. Provisional Patent Application Ser. No. 60/895,580, which was filed on 19 Mar. 2007 and entitled “Simultaneous UL Scheduling and HO Request.”

### TECHNICAL FIELD

The present invention generally relates to wireless communication networks, and particularly relates to reducing interference in such networks by enabling more opportune handover of mobile stations between cells.

### BACKGROUND

Controlling or otherwise limiting interference is a long-standing challenge in the design of wireless communication systems. The challenge becomes more acute as transmission data rates increase, achieved in some cases using more sophisticated signal structures and modulation formats. For example, the Long Term Evolution (LTE) of the Third Generation Partnership Project (3GPP) includes new modulation formats, both in the uplink (UL) and in the downlink (DL). For the uplink, LTE uses Single Carrier Frequency Division Multiple Access (SC-FDMA), while it uses Orthogonal Frequency Division Multiple Access (OFDMA) on the downlink.

The SC-FDMA and OFDMA modulation formats typically do not support spreading or processing gain. By contrast, for example, Wideband CDMA (WCDMA) signal structures do offer such gain, making them more robust in the presence of interference. Still, the intention is to be able to use LTE in a reuse one fashion, i.e. where neighboring cells in a wireless communication network use the same carrier frequency. Having different LTE users served in neighboring cells on the same frequency presents challenges regarding interference coordination and/or mitigation between cells. Broadly, the reuse of carrier frequencies and/or other channelization resources between neighboring cells raises potentially significant interference concerns, particularly where non-spreading modulation formats are used for the transmitted communication signals.

The potential for interference issues to arise in such systems is heightened under certain circumstances, and under certain conditions. For example, wireless communication system designers sometimes refer to mobile stations as “going around a corner,” meaning that a given mobile station suffers a potentially significant and rapid change in path loss. These changes occur, for example, where the mobile station moves in such a way that the propagation paths between it and serving cell/neighboring cells of a supporting wireless communication are significantly changed.

The around-the-corner scenario can be particularly problematic in scenarios where the mobile station requests an UL scheduling allocation from its serving cell, is granted the requested allocation, but then experiences a sudden increase in path loss before or during its scheduled UL transmission. In such cases, the mobile station will increase the transmit power it uses for the scheduled transmission, to compensate for the increased path loss. Such increases can be significant, and, at least for that scheduled transmission, the mobile station becomes a potentially significant source of interference with respect to neighboring cells in the network.

LTE and other types of networks are vulnerable to the above interference scenarios. In LTE-based networks, a mobile station recognizes that it has UL data to transmit, and it correspondingly sends an UL scheduling request. The request comprises, for example, a relatively small number of bits indicating to the network that the mobile station would like to transmit on the UL, and indicating the amount of data to be transmitted. In this regard, the mobile station may include in the transmitted request an indication of the number of bits in its transmit buffer that are awaiting UL transmission.

The base station, e.g., enhanced Node B (eNodeB), providing the mobile station's serving cell receives the UL scheduling request and correspondingly grants the request by sending a scheduling allocation to the mobile station. The scheduling allocation information identifies, for example, the UL resource blocks (time/frequency) that have been allocated to the mobile station for its desired UL transmission. The mobile station thus receives the scheduling allocation information and correspondingly carries out its UL transmission using the allocated UL resources. That UL transmission is directed to the serving cell and, to the extent that the path conditions between mobile station and the serving cell deteriorate significantly before the scheduled UL transmission, the mobile station's scheduled UL transmission may pose significant other-cell interference concerns. That is, the path loss differences between the serving cell (SC) and neighboring cells (NCs) may vary significantly. As such, while the mobile station's transmit power may be appropriate with respect to the path loss between the mobile station and the serving cell, it may be significantly too high as regards the neighboring cells that currently are experiencing less path loss with respect to the mobile station. In extreme cases, path loss difference of up to 30 dB can occur under 0.5 seconds. In such cases, when the mobile station begins the scheduled transmission to its SC, there is a significant risk of interfering neighboring cells.

Of course, the process of changing the mobile station from one serving sector to another as path loss conditions change tends to reduce the occurrence of the above interference problem. For example, it is known for a mobile station to measure and compare the signal strengths of its current serving cell and one or more neighboring cells, to see whether it should initiate handover from its current serving cell to a new serving cell. In this manner, the cell having the best signal conditions relative to the mobile station at any given time generally is the cell used to serve the mobile station.

However, overly frequent handovers are problematic in their own right, given the increased signaling and processing overhead needed to carry them out, and, as such, mobile stations generally use some form of handover measurement filtering or handover control hysteresis, which has a tendency to slow down handover initiations by the mobile stations. To the extent that handover evaluations are made at time inopportune with respect to such mobile stations requesting scheduled uplink transmissions, there are still significant windows of vulnerability to the previously described around-the-corner problems.

Correspondingly, then, it has been proposed for LTE at least, that eNodeBs be configured to transmit overload indicators, that dynamically indicate conditions of high uplink interference. As such, a mobile station could discern whether its transmissions are causing excessive interference in neighboring cells by monitoring the overload indicators being transmitted in those neighboring cells. There are certain complexities attending this approach, however, such as increased signaling overhead associated with transmitting the indicators, and increased mobile station complexity associated with receiving and processing the indicators from multiple eNodeBs.

### SUMMARY

According to the teachings presented herein, wireless communication network interference is reduced by sending handover measurement information from mobile stations in conjunction with sending uplink scheduling requests, and by correspondingly making combined handover and uplink resource scheduling decisions. In this context, the combined decision considers both the handover measurement information and the uplink scheduling request, and determines whether a serving cell grants or denies the request and whether handover from the serving cell to a neighboring cell is or is not initiated for the mobile station. The combined determination provides for timely handover of the mobile station, such as where the mobile station is operating near a cell edge and issues an uplink scheduling request to its currently serving cell.

Accordingly, in one embodiment, a base station is configured to reduce interference in a wireless communication network. The base station, e.g., an eNodeB in an LTE network, includes one or more processing circuits configured to receive handover measurement information from the mobile station in conjunction with receiving an uplink scheduling request from the mobile station, and determine a combined handover and uplink resource scheduling decision. The combined decision is based on the uplink scheduling request and handover measurement information and it determines whether the base station initiates handover of the mobile station to a neighboring base station and whether uplink resources are allocated to the mobile station from the base station or from the neighboring base station.

In this context, the combined decision being based on the uplink scheduling request and the handover measurement information means, in one or more embodiments, that the handover measurement information is evaluated with the explicit recognition that the mobile station will, in view of its UL scheduling request, be transmitting in the near-term future. Doing so allows the serving base station to prospectively consider whether the mobile station should be handed over to a neighboring base station, and whether, if such handover is deemed desirable, the UL scheduling requested should be granted from the serving base station before initiating the handover, or granted from the targeted neighboring base station after handover. Further, in one or more embodiments, the handover measurement information is evaluated not only in recognition of the mobile station's pending UL transmission, but further in view of the UL resource allocation needed to grant the request.

In complementary fashion, a mobile station in one or more embodiments is configured to reduce interference in a wireless communication network. The mobile station includes one or more processing circuits configured to maintain handover measurements at the mobile station for a serving cell and a neighboring cell, and send handover measurement information from the mobile station in conjunction with sending an uplink scheduling request from the mobile station. In one or more embodiments, the mobile station conditionally sends the handover information, such as in dependence on the relative signal strengths of the serving and neighboring cells, and/or in dependence on whether a received or configured indicator indicates that such sending is desired.

However, the present invention is not limited to the above summary of features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is block diagram of one embodiment of a wireless communication network configured according to the teachings presented herein.

FIG. 2 is a block diagram of one embodiment of a mobile station configured to send handover measurement information in conjunction with sending uplink scheduling requests.

FIGS. 3 and 4 are logic flow diagrams for embodiments of mobile station processing logic, such as may be implemented in the mobile station of FIG. 2.

FIGS. 5A and 5B are diagrams of example message formats to be used for sending handover measurement information in conjunction with sending UL scheduling requests.

FIG. 6 is a block diagram of one embodiment of a base station, e.g., a nodeB or eNodeB, configured to determine combined handover/uplink (HO/UL) scheduling decisions as taught herein.

FIG. 7 is a logic flow diagram for an embodiment of base station processing logic, such as may be implemented in the base station of FIG. 6.

### DETAILED DESCRIPTION

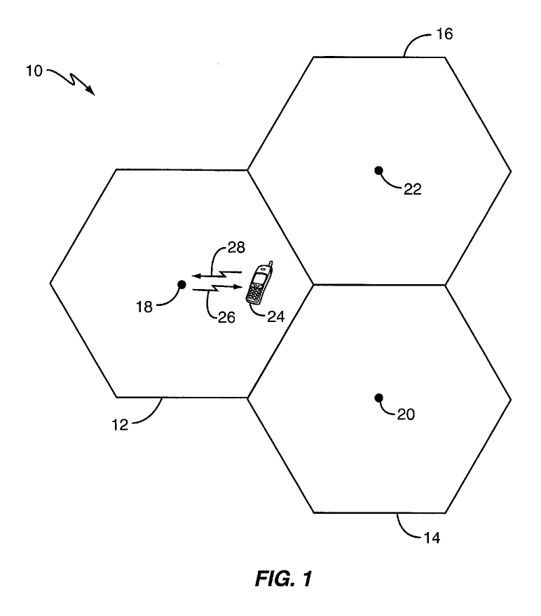

FIG. 1 partially illustrates a wireless communication network 10, including a number of cells 12, 14, and 16, each include a respective base station 18, 20, or 22. Different reference numbers as applied to cells and base stations provide for ease of discussion and are not meant to imply that any one cell or base station is different from the others. Further, it will be appreciated that actual network implementations may contain many cells and many base stations, and may support many mobile stations. Still further, the term “cell” in at least one embodiment connotes any defined radio coverage area provided by a given base station, and is intended to be construed broadly to encompass sectors, sectorized cells, micro-cells, etc.

One sees that a mobile station 24 is operating within the cell 12. Here, the cell 12 is considered the mobile station's current serving cell (SC). The adjacent cells 14 and 16 are neighboring cells (NCs). With the cell 12 being the mobile station's SC, and the base station 18 correspondingly operating as the mobile station's serving base station, the mobile station 24 receives downlink signals 26 from the base station 18 and transmits uplink signals 28 to the base station 18.

Of course, the neighboring base stations 20 and 22 generally can “hear” the mobile station's uplink transmissions and, indeed, in many reuse one scenarios, such transmissions represent interference in the NCs. Likewise, the mobile station 24 generally can “hear” transmissions from the neighboring base stations 20 and 22, even though it may not process them. Indeed, the mobile station 24 generally monitors pilot or other information from NCs and from its current SC, to detect whether signal conditions have changed such that one of the NCs offers a better signal quality than the current SC. That is, each NC generally is a candidate for becoming the mobile station's serving cell, depending upon changes in the propagation paths between the mobile station 24 and the base stations 18, 20, and 22.

For example, the mobile station 24 may be configured to carry out conventional HO processing in addition to the novel teachings presented herein. With conventional handover processing, the mobile station 24 initiates handover from a current SC to a NC whenever it detects that the NC offers it better signal quality that its current SC. However, irrespective of whether the mobile station 24 carries out conventional handover processing, it is configured according to the teachings presented herein to reduce interference in the network 10 by sending HO measurement information in conjunction with sending UL scheduling requests. Doing so permits one or more of the base stations 18, 20, and 22 to prospectively initiate handover of the mobile station 12 as part of determining a combined handover and uplink scheduling request decision.

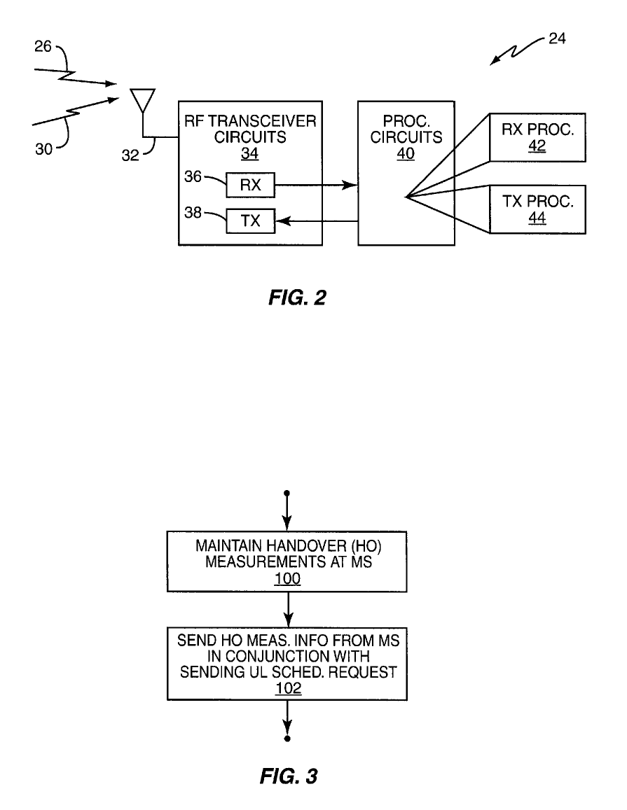

In turning to supporting details at the mobile station 24, one may refer to the example embodiment illustrated in FIG. 2. The mobile station 24 receives downlink signals 26 from its SC and downlink signals 30 from a NC, on its one or more receive antennas 32. (Those skilled in the art will appreciate that downlink signals may be received from multiple NCs.)

Radiofrequency (RF) transceiver circuits 34 initially condition/process the antenna received signals. For example, the RF transceiver circuits 34, which include receiver circuits 36 and transmitter circuits 38, may filter, amplify, down-convert and digitize the antenna-received signals, such that the one or more processing circuits 40 are presented with baseband or intermediate frequency digital sample streams representing the antenna-received signals. In this regard, the one or more processing circuits 40 may comprise one or more microprocessor-based or DSP-based circuits that are configured to carry out received signal processing. They of course also may be configured to carry out transmit signal processing and other system functions of the mobile station 24. For example, the one or more processing circuits 40 include a receiver processor 42 and a transmit processor 44.

The mobile station 24 is configured in at least one embodiment to carry out the method illustrated in FIG. 3. Such processing, which may be implemented in hardware, software, or any combination thereof, may be carried out on an ongoing basis. In any case, the illustrated processing includes the mobile station 24 maintaining HO measurements (Block 100). More particularly, the HO measurements include received signal strength measurement information for the mobile station's current SC and for one or more of the NCs. For example, if the current serving cell is the cell 12, the SC signal strength is evaluated by measuring the signal strength of downlink signals from the base station 18. Further, assuming that the cells 14 and 16 are NCs, the NC signal strengths are evaluated by measuring the signal strengths of downlink signals from the base stations 20 and 22.

Processing continues with the mobile station 24 sending HO measurement information to the SC in conjunction with sending an UL scheduling request to the serving cell (Block 102). The transmitted HO measurement information may be abbreviated to include information relating the SC to the strongest NC, or it may include information for additional NCs. In any case, those skilled in the art will appreciate that the UL scheduling requests are, in general, sent from the mobile station 24 on an as-needed basis, and it is preferable therefore to configure the mobile station 24 so that it refreshes its HO measurements frequently enough to serve the intended purpose of providing network base stations with reasonably current HO measurements in support of their making the combined HO/UL scheduling request decisions described herein.

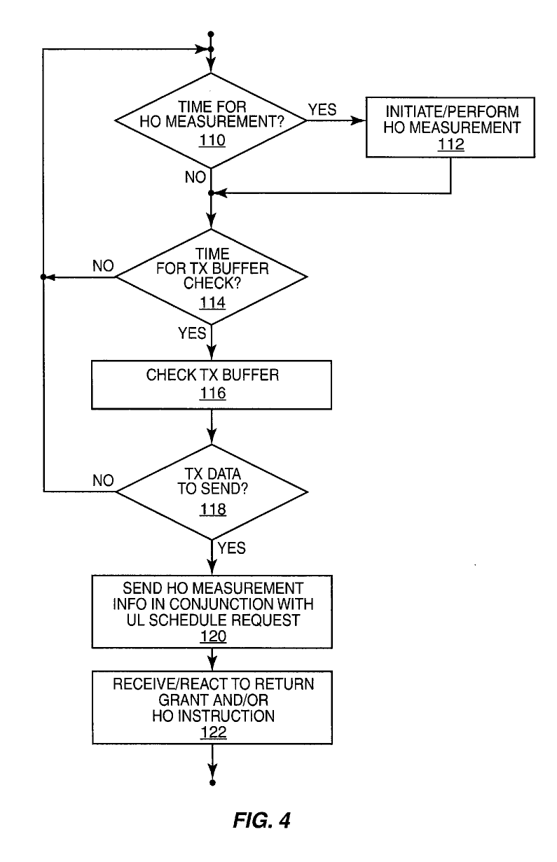

FIG. 4 provides a more detailed processing illustration, and includes a non-limiting example for timed, periodic HO measurement determinations at the mobile station 24. Particularly, the mobile station 24 maintains a timer (hardware or software) for periodically making HO measurements. The illustrated processing thus may be looped or otherwise repeated at time intervals, for example. As a non-limiting example, a 50 ms timer is used for performing HO measurements, and the transmit buffer is checked more frequently, such as every Transmit Time Interval (TTI), which is 1 ms in LTE.

In any case, the illustrated processing “begins” with the mobile station 24 determining whether it is time to perform HO measurements (Block 110). If so, the mobile station 24 performs or at least initiates HO measurement processing. (For example, it may initiate HO measurement processing and continue carrying out other processing.) Processing continues with determining whether it is time to check the mobile station's transmit buffer (Block 114), as a basis for determining whether the mobile station 24 needs to send an UL scheduling request. As noted above, the mobile station 24 in one or more embodiments uses independent timing intervals/timer mechanisms to time its transmit buffer checks and to refresh its HO measurements, and at least some aspects of the illustrated looped/timed processing may be carried out in parallel, or as background processing, etc. Further, in addition to appreciating that all or some of the FIG. 4 processing may be run in parallel with or as part of one or more other processing routines, and those skilled in the art will appreciate that the mobile station 24 may be performing any number of tasks between or as part of timing checks.

Assuming that it is time to perform transmit buffer checks (Yes from Block 114), processing continues with checking the transmit buffer (which may be memory within the one or more processing circuits 40) for any queued transmit data (Block 116). If there is no transmit data to send (No from Block 118), processing returns, for example, to the HO measurement timing check (Block 110).

On the other hand, if transmit data is queued in the transmit buffer (Yes from Block 118), processing continues with the mobile station 24 sending the current HO measurement information in conjunction with sending an UL scheduling request (Block 120). In at least one embodiment, the current HO measurement information is the most recently updated HO measurement information available in the mobile station 24. Processing continues further with the mobile station 24 receiving one or more return messages from the SC, e.g., from the base station 18 acting as the mobile's serving base station, and reacting to the return message(s) (Block 122). The return message(s) indicate, for example, whether the handover of the mobile station 24 from the SC to a NC will be performed, and whether mobile station 24 is or will be granted UL resources from the SC or from the NC.

Thus, in one or more embodiments, the mobile station 24 is configured to carry out signal strength measurements for its SC and one or more NCs on a regular basis, and to periodically check its transmit buffer for data to transmit. If there is data to transmit, the mobile station 24 sends its current HO measurement information in conjunction with sending a UL scheduling request. Note that in at least one embodiment, the mobile station sends the HO measurement information in conjunction with the UL scheduling request only if the strongest NC is within a certain range (in dB) to the SC.

In another embodiment, such conjunctive sending of HO measurement information is optional and is selectively enabled for certain base stations. For example, base stations near tunnels, large structures, or other environments where sudden path loss changes may be more likely, can be configured to make combined HO/UL scheduling decisions in view of receiving HO measurement information in conjunction with receiving UL scheduling requests. On the other hand, other base stations in areas not particularly susceptible to rapid and/or dramatic path loss changes may not make combined HO/UL scheduling decision and therefore do not need to receive HO measurement information in conjunction with receiving UL scheduling requests. (In such coverage areas, mobile-initiated handover processing may nonetheless be carried out as needed, as is known in the art.)

Mobile stations can be configured with information that indicates which base stations or which service areas make combined HO/UL scheduling requests, such that they send HO measurement information in conjunction with sending UL scheduling requests for such areas, but omit HO measurement information when sending UL scheduling requests in other areas. Alternatively, base stations can be configured to broadcast, or otherwise signal whether they are configured to make combined HO/UL decisions, and mobile stations can use these signaled indications to control whether HO measurement information is sent in conjunction with making UL scheduling requests. Note, too, that in at least one embodiment, the network 10 is “adaptive” or self-configuring. For example, the network 10 can be configured to automatically detect where the combined HO/UL scheduling decision feature shall be enabled based on handover and uplink interference measurements. For example, if severe uplink interference peaks are frequently followed by handover requests in and around certain base stations, the network 10 enables the combined HO/UL scheduling decision feature for the affected base stations.

In such embodiments, then, those base stations can turn on the combined HO measurement reporting and UL scheduling request transmissions for mobile stations in their coverage areas by sending configuration messages to those mobiles. Messages are broadcasted or sent through Radio Resource Control (RRC) signaling. As such, the reporting overhead will be incurred only in cells and areas where the combined decision processing is active. Of course, a given base station can be configured to ignore or otherwise not use HO measurement information sent in conjunction with UL scheduling requests if the combined decision feature is not active at that base station.

In an LTE embodiment, determining whether to enable the combined decision feature can be decided by the nodeBs in the network 10. Either originating nodeBs can make the enable decision, or that decision can be made by “interfered” nodeBs. An originating nodeB is a nodeB acting as a serving base station for a given mobile station. As such, it is in a position to receive interference information from a neighboring base station corresponding to mobile stations that initiate handover from it to the neighboring base station. For example, a given mobile station may undergo handover to a particular neighboring base station, where that neighboring base station sends overload indicators back to the originating base station over the “X2” interface between them. The overload indicators provide the originating base station with information about the interference caused by the mobile station, e.g., immediately before or during its handover. In an interfered nodeB, i.e., a nodeB that suffers interference from a mobile station before the mobile station is handed over to it from the originating nodeB, the interference measure as well as handover request are available. A configuration message can be sent over the X2 interface to the originated nodeB (where the handover request came from) to activate the combined decision feature at the originating nodeB.

Of course, whether implemented according to LTE or otherwise, one or more base stations in the network 10 can be configured to evaluate whether previously detected uplink interference peaks by given mobile stations were correspondingly followed by handover requests. Such information may be maintained in running historical records held within base station memories or storage devices. Using that information and a frequency-of-occurrence threshold, base stations may selectively enable or disable the combined decision feature based on determining whether detected interference peaks are followed by handovers at greater than a defined frequency of occurrence. (Here, “followed by” can be defined in terms of temporal separation between the detected interference peak and the subsequent handover event. Handovers within a few seconds of detected interference peaks, for example, can be considered as correlated events.)

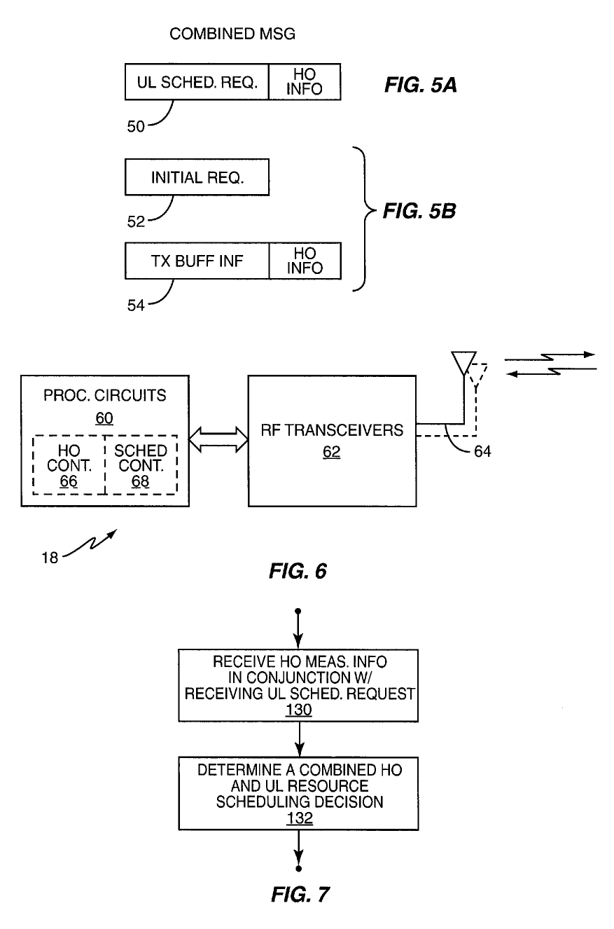

Turning back to the mobile station messages that support the combined decision making at base stations, FIGS. 5A and 5B indicate example but non-limiting variations of sending HO measurement information from the mobile station 24 in conjunction with sending UL scheduling requests. In the example of FIG. 5A, the mobile station 24 is configured to include the HO measurement information in a combined message 50, which includes the UL scheduling request information together with the HO measurement information. In the example of FIG. 5B, the mobile station 24 requests UL scheduling grants by sending an initial request message 52 that may be quite small (e.g., a few bits). The serving base station, e.g., base station 18, allocates limited UL resources to the mobile station 24 in response, which the mobile station 24 then uses to send a corresponding second message 54, which may be larger than the first message 52. The second message 54 includes, in at least one embodiment, a transmit buffer report (e.g., transmit buffer status) along with the HO measurement information. The base station can determine the UL resource allocation that will be needed to grant the request based on evaluating the transmit buffer status.

Such multi-message requests may be used to particular advantage in LTE embodiments of the network 10, base stations 18, 20, 22, and mobile station 24. In LTE, two phases may be used for scheduling uplink transmissions involving larger amounts of data. First, the mobile station 24 sends a scheduling request with limited information (e.g., 1 bit). The receiving base station schedules a limited amount of resource blocks (e.g., 1-2), to avoid wasting resources. The mobile station 24 then uses that limited allocation to send a more detailed transmit buffer report along with the first uplink data. With this additional buffer information, the base station can make the appropriate additional allocation of uplink resources, as necessary or desired. In this scenario, the initial request does not accommodate HO measurement information inclusion.

On the other hand, the HO measurement information can easily be included in the subsequent transmission of the more detailed transmit buffer report. Doing so provides the receiving base station with HO measurement information to consider in view of the transmit buffer report details, which may indicate that a larger amount of UL resource blocks need to be scheduled for the mobile station 24. This two-message process and evaluation will be on the order of 10 ms or so, and that time is insignificant compared to the handover filtering controls typically used in the mobile station 24, meaning that, for the pending UL transmission, the base station can make a faster handover decision than can be made by the mobile station 24.

Further to that point, as contemplated herein, the UL resources needed to grant the UL scheduling request may be directly considered by the base station in making the combined HO/UL scheduling decision. For example, in one embodiment, the mobile station's serving base station may choose to grant UL resources from the mobile's SC without initiating handover to a NC, if the UL resources needed to grant the mobile's request are at or below defined thresholds. As non-limiting examples, such thresholds may be defined explicitly in terms of the number of UL transmit blocks or slots needed, or implicitly in terms of the amount of UL data to be transmitted. Conversely, if a defined UL allocation threshold is exceeded, the serving base station may choose to initiate handover, such that the needed UL resources are allocated from the NC after handover rather than from the SC.

Accordingly, the mobile station 24 according to the above teachings is configured to reduce interference of the network 10, based on its comprising one or more processing circuits 40 that are configured to send handover measurement information in conjunction with sending UL scheduling requests. The mobile station's processing circuits 40 maintain handover measurements at the mobile station 24 for a serving cell and a neighboring cell. The handover measurement information is, in at least one embodiment, signal strength measurements (in a relative or absolute sense) for the mobile station's SC and one or more of NCs. For example, the mobile station 24 maintains received signal strength measurement information for base station 18 as a serving base station/SC and for base station 20 as a neighboring base station/NC.

As noted, the processing circuits 40 are further configured to send handover measurement information from the mobile station 24 in conjunction with sending an uplink scheduling request from the mobile station 24. Such processing circuits 40 are, in at least one embodiment, configured to conditionally send the handover measurement information. For example, in at least one embodiment, they are configured to send or not send the handover measurement information in dependence on relative signal strengths of the SC and the NC. For example, conditionally sending the handover measurement information comprises sending or not sending the handover measurement information in dependence on a signal strength of the NC relative to the SC. As a further example, in at least one embodiment, the one or more processing circuits 40 are configured to send or not send the handover measurement information in dependence on a received or configured control indicator. (The indicator, e.g., a bit or other logical “flag,” may be set or cleared based on information signaled by given base stations, or may be set or cleared as a configured value. These conditional restraints on sending the HO measurement information are combined in at least one other embodiment, and those skilled in the art will readily appreciate that other conditions may additionally or alternatively be used.

As further useful variations, it was noted in the context of FIG. 5A that the one or more processing circuits 40 may be configured to send handover measurement information in conjunction with sending an uplink scheduling request by sending an uplink scheduling request message 50 that includes the handover measurement information. Alternatively, the HO measurement information can be sent in any one of two or more messages or other transmissions that together serve as an UL scheduling request—see FIG. 5B. For example, the HO measurement information can be omitted from an initial short request message 52, but included in a subsequent corresponding transmit buffer report or other longer, follow-up message 54. Thus, the one or more processing circuits 40 are in at least one embodiment configured to send an initial message without the HO measurement information, such that the mobile station 24 receives a corresponding uplink resource allocation, and then send a related second message using the uplink resource allocation, where that related second message includes the HO measurement information and transmit buffer status.

Of course, the teachings herein contemplate complementary base station configurations, where given base stations are configured to exploit the HO measurement information as received from mobile stations, for making combined HO/UL scheduling decisions. These combined decisions, as explained earlier, enable base stations to make prospective handover decisions in view of pending scheduled transmissions by mobile stations, as a mechanism for reducing interference in the network 10. For example, a given combined decision may involve, in response to receiving an UL scheduling request from a mobile station, handing over the mobile station from its current SC to a target NC before UL resources are allocated to it. That action would be taken, for example, where the HO measurement information indicates that the NC cell signal strength is within a defined threshold of the SC signal strength. Such conditions suggest the mobile station is in or moving towards a position where directing the scheduled transmission toward the NC rather than the current SC will cause less interference in the network 10.

With this advantageous operation in mind, FIG. 6 illustrates an example embodiment of the base station 18. (The same implementation or variations of this implementation also may be adopted for base stations 20, 22, etc.) The illustrated embodiment includes processing circuits 60, RF transceivers 62, and one or more transmit/receive antennas 64. (Multiple antennas may be implemented for diversity, MIMO, etc.) The processing circuits 60 may be included computer systems, e.g., microprocessor-based circuits with supporting computer program instructions stored on included computer readable media. Functionally, they include an HO controller 66 and a scheduling controller 68.

The HO controller 66 may be configured to support the novel combined HO/UL scheduling decisions determined herein, and also may be configured to support any conventional HO processing as needed or desired. The scheduling controller 68 also is configured to support determining the combined HO/UL scheduling decisions taught herein. It is also contemplated to include a combined-functionality logical processor within the processing circuits 60, to make the combined HO/UL scheduling decisions taught herein.

In any case, as shown in FIG. 7, the base station 18 may be configured to receive HO measurement information from the mobile station 24 in conjunction with receiving an UL scheduling request from the mobile station 24 (Block 130). The base station 18 then determines a combined HO/UL scheduling decision for the mobile station 24, based on the HO measurement information and the UL scheduling request (Block 132).

Regarding signaling from the mobile station 24, in one embodiment, the base station 18 receives a combined message 50 as shown in FIG. 5A and it is configured to process the combined message 50 to recover both UL schedule request information and HO measurement information. The recovered information can be considered by the controllers 66 and 68, for example. Additionally, or alternatively, the base station 18 receives an initial request message 52 as shown in FIG. 5B, and is configured to make an initial, limited UL scheduling grant, which the mobile station 24 uses to send a second message 54 that includes the HO measurement information. In such embodiments, the base station 18 is configured to process the second message to recover the HO measurement information and to recover any other included information, such as transmit buffer reports from the mobile station 24.

With the above in mind, it will be appreciated that the base station 18 (or 20, 22) is configured to implement a method of reducing interference in the network 10. The method includes receiving HO measurement information from the mobile station 24 in conjunction with receiving an uplink scheduling request from the mobile station 24, and determining a combined HO/UL resource scheduling decision. That combined decision is based on the uplink scheduling request and HO measurement information. In at least one embodiment, the HO measurement information includes or otherwise indicates SC and NC signal strength information. That is, the HO measurement information conveys signal strength measurement information as maintained at the mobile station 24 for its current SC and for at least one NC. Such information may comprise absolute or relative signal strengths, and may be unfiltered, filtered, quantized, or otherwise processed as desired.

The combined HO/UL decision is a combined decision at least in the sense that the base station 18 evaluates the HO measurement information with the recognition that the mobile station 24 wishes to transmit data on the UL, and that this is therefore an opportune time to determine whether handover of the mobile station 24, either before or after the requested scheduled UL transmission, will reduce the risk of interference caused by the mobile station 24. Further, in at least one embodiment, the base station 18 evaluates the HO measurement information not only in recognition that UL transmission from the mobile station 24 is pending, but also in consideration of the actual UL resource allocation that will be needed to grant the request. For example, a longer UL transmission by the mobile station 24 is more at risk of becoming an interference problem if the mobile station 24 is in a boundary area between its SC and NC, as can be discerned from evaluating SC and NC signal strengths indicated in the HO measurement information.

More generally, handover should be prospectively considered by the base station 18 any time the HO measurement information received from the mobile station 24 in conjunction with an UL scheduling request indicates that the path loss between the mobile station 24 and its SC is at or near the path loss between it and its best or closest neighboring cell. For example, the processing circuits of the base station 18 may be configured to use a defined threshold (adjustable or otherwise) set in terms of dB, percentages, etc., such that SC and NC signal strengths within a defined threshold trigger prospective handover initiation by the base station 18 as part of the base station 18 making the combined HO/UL scheduling decision. As a general proposition, this prospective initiation reduces the amount of time that a given mobile station remains tied to its current serving cell as it moves toward or into coverage areas better served by a neighboring cell.

In at least one embodiment, the base station 18 operates with a first threshold for evaluating the HO measurement information, for UL schedule requests that implicate UL resources below a defined allocation threshold. Further, the base station 18 operates with a second threshold for evaluating the HO measurement information, for UL schedule requests that implicate UL resources above the defined allocation threshold. Using different thresholds, which may be pre-configured or dynamically set, or pre-configured and then dynamically revised, allows the base station 18, for example, to be more aggressive in initiating HO of the mobile station 24 in response to receiving an UL scheduling request from the mobile station 24.

In any case, it should be understood that the combined HO/UL resource scheduling decision determines whether a SC initiates handover of the mobile station 24 to a NC and whether uplink resources are allocated to the mobile station from the serving cell or from the neighboring cell. In at least one embodiment, the SC receives the UL scheduling request in conjunction with the HO measurement information, and the SC determines the combined decision.

Determining the combined HO/UL scheduling decision comprises, in one or more embodiments, deciding on one of the following actions: granting the scheduling request from the SC with no handover to the NC; granting the scheduling request from the SC and subsequently initiating handover to the NC; not granting the scheduling request from the SC and initiating handover to the NC as the new SC for the mobile station. That latter action of not granting the scheduling request from the SC and initiating handover to the NC may also include the SC communicating with the NC to obtain a granting of the scheduling request from the NC, and correspondingly communicating granting information to the mobile station 24. Alternatively, the SC may simply initiate handover to the NC and leave it to the mobile station 24 to re-send its UL scheduling request once it has completed handover to the NC. (Note that here and elsewhere in this disclosure, ascribing functional processing capabilities to cells should be understood as indicating that the base stations or other wireless communication network processing entities associated with those cells provide such processing.)

Broadly, then, the teachings presented herein tie UL scheduling requests and HO measurements to each other. For example, in one or more embodiments, mobile stations are configured to transmit SC and NC measurement information in conjunction with transmitting UL scheduling requests. Supporting base stations thus can make combined HO/UL scheduling decisions, such as prospectively ordering mobile stations to do handovers prior to sending their data and thereby moving them into the correct cells (with respect to signal strength) prior to their starting their scheduled uplink data transmissions. The disclosed teachings therefore permit a given mobile station to make the handover decision for a given mobile station before that mobile station's own handover control mechanism would have triggered handover. Doing so thus makes the handover happen sooner than it otherwise would have happened. This faster handover decision therefore gets the mobile station into the correct cell sooner, and therefore reduces the risk of that mobile station interfering with neighboring cells.

In a non-limiting embodiment, the network 10 comprises an LTE network, the base stations 18, 20, and 22 comprise LTE base stations, and the mobile station 24 comprises an LTE mobile station. As applied to that context in a non-limiting sense, and assuming reuse one across the cells 12, 14, and 16, the teachings herein advantageously provide for configuring the mobile station 24 to reduce interference in the network 10 by sending handover (HO) measurement information in conjunction with sending UL scheduling allocation requests. As a further advantage, the teachings provide for configuring the base station 18 (and/or the base stations 20 and 22) to reduce interference in the network 10 by receiving the HO measurement information from the mobile station 24 in conjunction with receiving the UL scheduling allocation request, and determining a combined handover and uplink resource scheduling decision based on the HO measurement information and the request. Interference reduction according to these teachings results from making more opportune HO decisions in view of pending scheduled transmissions by given mobile station.

In other words, by receiving current HO measurement information from the mobile station 24 at the base station 18 contemporaneously with receiving an UL scheduling request from the mobile station 24, the base station 18 can prospectively decide to initiate handover of the mobile station 24 to a neighboring base station, e.g., 20 or 22, in view of the mobile station's pending UL transmission. Of course, it will be understood that the mobile station 24 still may be configured to carry out conventional HO processing independent from and in addition to the teachings presented herein, such that the mobile station 24 and/or the network 10 make HO decisions based on the mobile's movement in and through the network 10.

With these and the other teachings presented herein, those skilled in the art will appreciate that the present invention logically ties HO measurement information to UL schedule requests. Mobile stations send HO measurement information in conjunction with sending UL scheduling requests, and, correspondingly, their supporting base stations make combined HO/UL scheduling decisions based on the HO measurement information and the UL scheduling requests. This approach allows base stations to trigger handovers for mobile stations with pending UL transmissions sooner than they otherwise would occur if handover initiation is left to mobile station initiation processing. As such, the present invention is not limited to the foregoing discussion and accompanying drawings. Instead, the present invention is limited only by the following claims and their legal equivalents.

What is claimed is:

1. A method of reducing interference in a wireless communication network comprising:
maintaining handover measurements at a mobile station for a serving cell and a neighboring cell; and
sending handover measurement information from the mobile station in conjunction with sending an uplink scheduling request from the mobile station.

2. The method of claim 1, wherein sending handover measurement information from the mobile station in conjunction with sending an uplink scheduling request from the mobile station comprises conditionally sending the handover measurement information.

3. The method of claim 2, wherein conditionally sending the handover measurement information comprises sending or not sending the handover measurement information in dependence on a signal strength of the neighboring cell relative to the serving cell.

4. The method of claim 2, wherein conditionally sending the handover measurement information comprises sending or not sending the handover measurement information in dependence on a received or configured control indicator.

5. The method of claim 1, wherein sending handover measurement information from the mobile station in conjunction with sending an uplink scheduling request from the mobile station comprises sending an uplink scheduling request message that includes the handover measurement information.

6. The method of claim 1, wherein sending handover measurement information from the mobile station in conjunction with sending an uplink scheduling request from the mobile station comprises sending an initial message without the handover measurement information and receiving a corresponding uplink resource allocation, and sending a related second message using the uplink resource allocation, said related second message including the handover measurement information and transmit buffer status.

7. A mobile station configured to reduce interference in a wireless communication network, said mobile station comprising one or more processing circuits configured to:
maintain handover measurements at the mobile station for a serving cell and a neighboring cell; and
send handover measurement information from the mobile station in conjunction with sending an uplink scheduling request from the mobile station.

8. The mobile station of claim 7, wherein the one or more processing circuits are configured to conditionally send the handover measurement information.

9. The mobile station of claim 8, wherein the one or more processing circuits are configured to send or not send the handover measurement information in dependence on relative signal strengths of the serving and neighboring cells.

10. The mobile station of claim 8, wherein the one or more processing circuits are configured to send or not send the handover measurement information in dependence on a received or configured control indicator.

11. The mobile station of claim 7, wherein the one or more processing circuits are configured to send handover measurement information from the mobile station in conjunction with sending an uplink scheduling request by sending an uplink scheduling request message that includes the handover measurement information.

12. The mobile station of claim 7, wherein the one or more processing circuits are configured to send handover measurement information from the mobile station in conjunction with sending an uplink scheduling request by sending an initial message without the handover measurement information and receiving a corresponding uplink resource allocation, and sending a related second message using the uplink resource allocation, said related second message including the handover measurement information and transmit buffer status.

13. A method of reducing interference in a wireless communication network comprising:
receiving handover measurement information from a mobile station in conjunction with receiving an uplink scheduling request from the mobile station; and
determining a combined handover and uplink resource scheduling decision based on the uplink scheduling request and handover measurement information, wherein the combined handover and uplink resource scheduling decision determines whether a serving cell initiates handover of the mobile station to a neighboring cell and whether uplink resources are allocated to the mobile station from the serving cell or from the neighboring cell.

14. The method of claim 13, wherein said receiving and said determining occur at the serving cell.

15. The method of claim 13, wherein determining the combined handover and uplink resource scheduling decision comprises deciding on one of the following actions: granting the scheduling request from the serving cell with no handover to the neighboring cell; granting the scheduling request from the serving cell and subsequently initiating handover to the neighboring cell; not granting the scheduling request from the serving cell and initiating handover to the neighboring cell.

16. The method of claim 15, wherein the action of not granting the scheduling request from the serving cell and initiating handover to the neighboring cell includes the serving cell communicating with the neighboring cell to obtain a granting of the scheduling request from the neighboring cell, and correspondingly communicating granting information to the mobile station.

17. The method of claim 13, wherein determining the combined handover and uplink resource scheduling decision based on the uplink scheduling request and the handover measurement information comprises evaluating serving cell and neighboring cell signal strength information as conveyed in the handover measurement information in view of the uplink resource allocation needed to grant the uplink scheduling request.

18. The method of claim 13, wherein receiving the handover measurement information comprises receiving an uplink scheduling request message that includes the handover measurement information.

19. The method of claim 13, wherein receiving the handover measurement information comprises receiving the handover measurement message in a transmit buffer report message sent from the mobile station in conjunction with sending an initial grant request message.

20. The method of claim 13, further comprising enabling or disabling the determination of combined handover and uplink resource scheduling decisions by the serving cell based on evaluating whether previously detected uplink interference peaks by given mobile stations were correspondingly followed by handover requests at greater than a defined frequency of occurrence.

21. The method of claim 13, wherein determining a combined handover and uplink resource scheduling decision based on the uplink scheduling request and handover measurement information comprises granting the scheduling request from the serving cell and subsequently initiating handover to the neighboring cell

22. The method of claim 13, wherein determining a combined handover and uplink resource scheduling decision based on the uplink scheduling request and handover measurement information comprises not granting the scheduling request from the serving cell and initiating handover to the neighboring cell as a new serving cell for the mobile station, for granting of the uplink scheduling request from the new serving cell.

23. A base station configured to reduce interference in a wireless communication network, said base station comprising one or more processing circuits configured to:
receive handover measurement information from the mobile station in conjunction with receiving an uplink scheduling request from the mobile station; and
determine a combined handover and uplink resource scheduling decision based on the uplink scheduling request and handover measurement information, wherein the combined handover and uplink resource scheduling decision determines whether the base station initiates handover of the mobile station to a neighboring base station and whether uplink resources are allocated to the mobile station from the base station or from the neighboring base station.

24. The base station of claim 23, wherein the base station is configured to determine the combined handover and uplink resource scheduling decision by deciding on one of the following actions: granting the scheduling request with no handover to the neighboring base station; granting the scheduling request and subsequently initiating handover to the neighboring base station; not granting the scheduling request and initiating handover to the neighboring base station.

25. The base station of claim 24, wherein, for the action of not granting the scheduling request and initiating handover to the neighboring base station, the base station is configured to communicate with the neighboring base station to obtain a granting of the scheduling request from the neighboring base station, and correspondingly communicate granting information to the mobile station.

26. The base station of claim 23, wherein the base station is configured to determine the combined handover and uplink resource scheduling decision by evaluating signal strength information for the base station and the neighboring base station relative to the mobile station, as conveyed in the handover measurement information, in view of the uplink resource allocation needed to grant the uplink scheduling request.

27. The base station of claim 23, wherein the base station is configured to receive an process an uplink scheduling request message from the mobile station that includes the handover measurement information.

28. The base station of claim 23, wherein the base station is configured to determine the combined handover and uplink resource scheduling decision based on the uplink scheduling request and handover measurement information as granting the scheduling request from the serving cell and subsequently initiating handover to the neighboring cell.

29. The base station of claim 23, wherein the base station is configured to determine the combined handover and uplink resource scheduling decision based on the uplink scheduling request and handover measurement information as not granting the scheduling request from the serving cell and initiating handover to the neighboring cell as a new serving cell for the mobile station, for granting of the uplink scheduling request from the new serving cell.
